(19) United States
(12) Patent Application Publication
(10) Pub. No.: US 2011/0205258 A1
(43) Pub. Date: Aug. 25, 2011

(54) BACKLIGHT UNIT, LIQUID CRYSTAL DISPLAY DEVICE, LUMINANCE CONTROL METHOD, LUMINANCE CONTROL PROGRAM, AND RECORDING MEDIUM

(75) Inventors: Shinji Suminoe, Osaka-shi (JP); Kohji Fujiwara, Osaka-shi (JP)

(73) Assignee: SHARP KABUSHIKI KAISHA, Osaka-shi, Osaka (JP)

(21) Appl. No.: 13/121,715

(22) PCT Filed: Jul. 6, 2009
(86) PCT No.: PCT/JP2009/062268

§ 371 Date: Mar. 30, 2011

(30) Foreign Application Priority Data
Oct. 10, 2008 (JP) 2008-263488

(51) Int. Cl. G09G 5/10

(52) U.S. Cl. 345/690; 345/102

(57) ABSTRACT

An LED controller (11) judges whether a temperature sensor (21) is normal in accordance with measured temperature data and controls luminance of an LED (32) measured by an abnormal temperature sensor (21) in accordance with alternative temperature data instead of the temperature data measured by the abnormal temperature sensor (21).

### TECHNICAL FIELD

The present invention is related to a backlight unit for use in a liquid crystal display device, a liquid crystal display device, a method and a program for controlling luminance (brightness) of light from a backlight unit, and a recording medium.

### BACKGROUND ART

In recent years, there have been developed backlight units using an LED (light emitting diode) as a light source as exemplified by the liquid crystal display device of Patent Literature 1 listed below. Specifically, such backlight units include a red-light-emitting (R) LED, a green-light-emitting (G) LED, and a blue-light-emitting (B) LED, to generate while light by mixing light from the LEDs.

LEDs (light sources) are environment-friendly since they do not need mercury in contrast to, for example, fluorescent tubes, and what is more, LEDs consume less power than fluorescent tubes. However, LEDs are heated by being driven, and the heat degrades their brightness. In particular, the brightness of a red-light-emitting (R) LED is more liable to be degraded than the brightness of a green-light-emitting (G) LED or the brightness of the blue-light-emitting (B) LED. Thus, when the temperature of an LED increases according to its operation time, the white light generated from the three colors of LED light are caused to include uneven chromaticity, uneven brightness, and the like.

To overcome this inconvenience, a backlight unit of Patent Literature 1 that uses the white light is provided with a temperature sensor for measuring a temperature of an LED. And, by using data of the temperature measured by the temperature sensor, a control portion adjusts the brightness of the LED. As a result, white light emitted from the backlight unit is less likely to include uneven chromaticity, uneven brightness and the like caused under the influence of the temperature of the LED.

### CITATION LIST

### Patent Literature

Patent Literature 1: JP-A-2006-31977

### SUMMARY OF INVENTION

### Technical Problems

However, there may be a case where the temperature sensor fails to operate normally. In such a case, the control portion included in the backlight unit is forced to control the brightness of the LED by using data of the temperature measured by the abnormal temperature sensor. This may result in, for example, an inconvenient situation where the control portion erroneously finds brightness degradation and carries out control even when the brightness of the LED is not degraded under the influence of heat (in short, the control portion may control the LED by using data of an erroneously measured temperature).

The present invention has been made to solve the above problem. And an object of the present invention is to provide a backlight unit, etc. capable of controlling a light source without using data of an erroneously measured temperature.

### Solution to Problem

A backlight unit includes: a plurality of light sources; temperature sensors that are provided corresponding to light source groups into which the plurality of light sources are divided; and a control portion that controls brightness of the light sources according to measured temperature data that is based on temperatures of the light sources included in the light source groups measured by the temperature sensors. In this backlight unit, the control portion judges whether the temperature sensors are normal or abnormal from the measured temperature data, and the control portion controls brightness of any of the light sources a temperature of which is measured by an abnormal temperature sensor of the temperature sensors, based not on measured temperature data of said abnormal temperature sensor but on substitute temperature data.

Such brightness control includes: a temperature sensor judgment step of judging whether the temperature sensors are normal or abnormal from the measured temperature data; and a substitute control step of controlling brightness of any of the light sources a temperature of which is measured by an abnormal temperature sensor of the temperature sensors, based not on the measured temperature data of the abnormal temperature sensor but on the substitute temperature data.

It can also be described as follow: a brightness control program makes the control portion perform brightness control such that judgment of whether the temperature sensors are normal or abnormal is made from measured temperature data, and that brightness of any of the light sources a temperature of which is measured by an abnormal temperature sensor is controlled based not on measured temperature data of the abnormal temperature sensor but on substitute temperature data.

In the backlight unit having the above features, brightness of the light sources is controlled without being based on measured temperature data measured by an abnormal temperature sensor. As a result, light outputted from the light sources has desired chromaticity and brightness, and this contributes to improvement of the quality of light from the backlight unit.

Preferably, the substitute temperature data is measured temperature data that is based on a temperature measured by a normal temperature sensor of the temperature sensors that is located closest to the abnormal temperature sensor.

The above-described measured temperature data, which is based on the normal temperature sensor that is located closest to the abnormal temperature sensor, is similar to the measured temperature data that would be acquired if the abnormal temperature sensor were normal. Thus, if the measured temperature data is used as the substitute temperature data, white light outputted from the light sources securely has desired chromaticity and brightness, and this contributes to improvement of the quality of light from the backlight unit.

Preferably, if a temperature sensor of the temperature sensors that is located closest to said abnormal temperature sensor, which is referred to as a first abnormal temperature sensor, is abnormal, the temperature sensor being referred to as a second abnormal temperature sensor, measured temperature data that is based on a temperature measured by a normal temperature sensor of the temperature sensors that is located closest to the second abnormal temperature sensor is used as the substitute temperature data. With this feature, brightness of the light sources is securely controlled without being based on data of a temperature measured by an abnormal temperature sensor.

Preferably, the substitute temperature data is previously determined temperature data.

With this feature, for example, in a case where three or more adjacent temperature sensors are abnormal, the control portion does not need to judge whether a temperature sensor located next to a third abnormal temperature sensor is normal or abnormal. This relieves the control portion of a burden of continuously searching for a normal temperature sensor

It can be said that the present invention includes a liquid crystal display device that includes the above-described backlight unit and a liquid crystal display panel that receives light from the backlight unit. It can also be said that the present invention includes a recording medium on which the brightness control program is recorded and that is readable by a computer.

### Advantageous Effects of Invention

According to a backlight unit of the present invention, a control portion identifies an abnormal temperature sensor, and adjusts the brightness of a light source not by using data of a temperature measured by the abnormal temperature sensor but by using substitute temperature data. Thus, the light source emits light not based on the data of the erroneously measured temperature but based on the substitute temperature data. As a result, light from the backlight unit has a high quality.

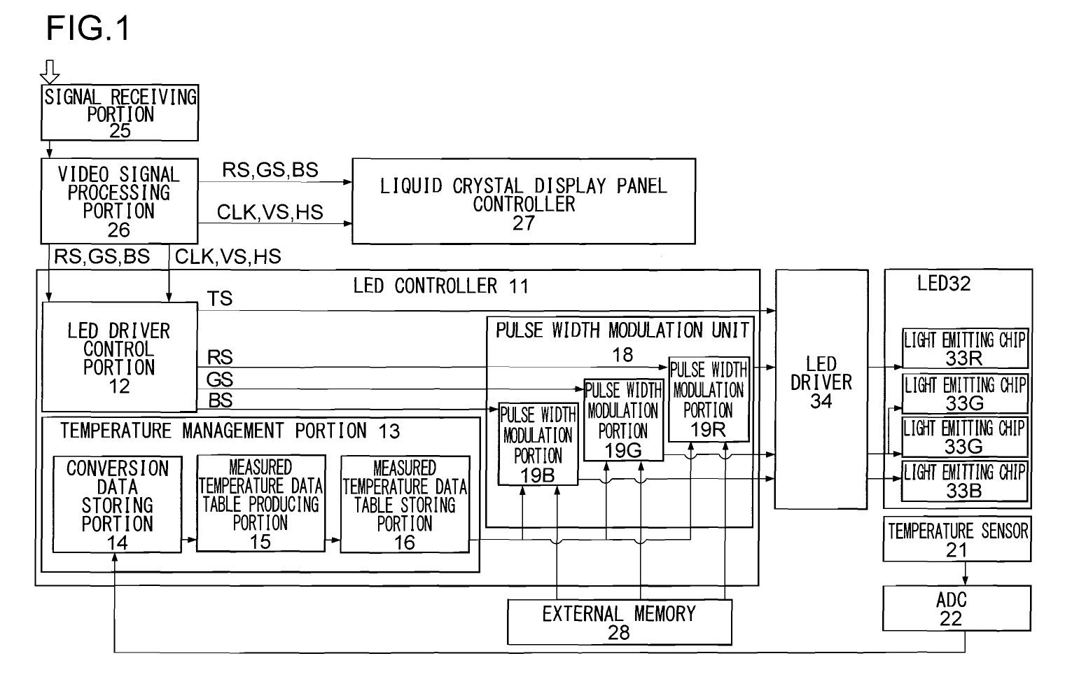

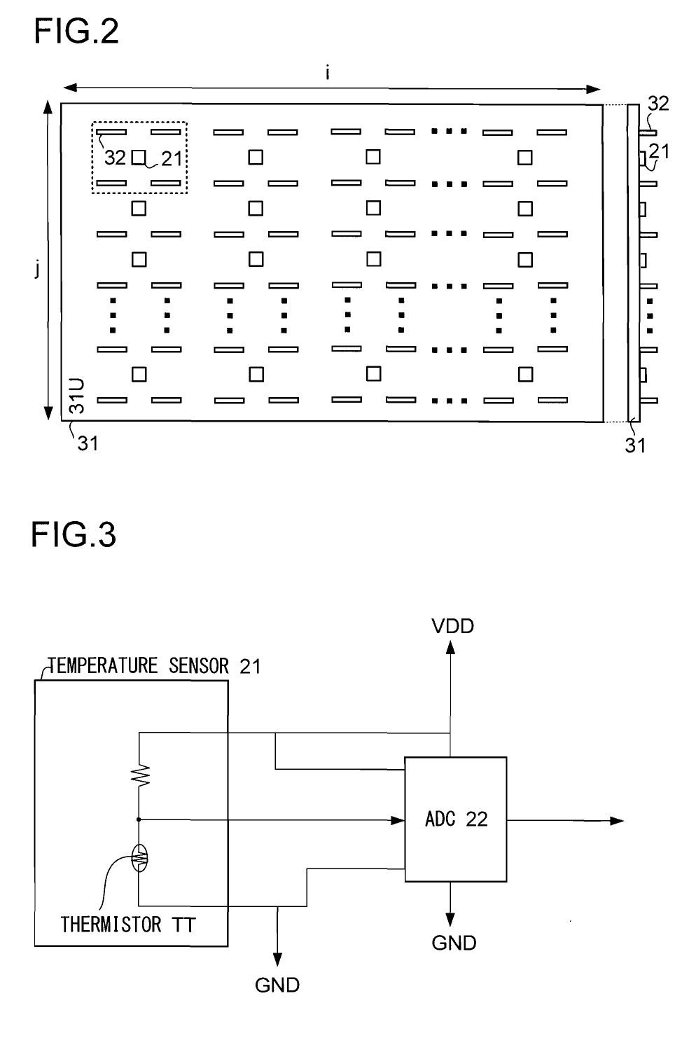

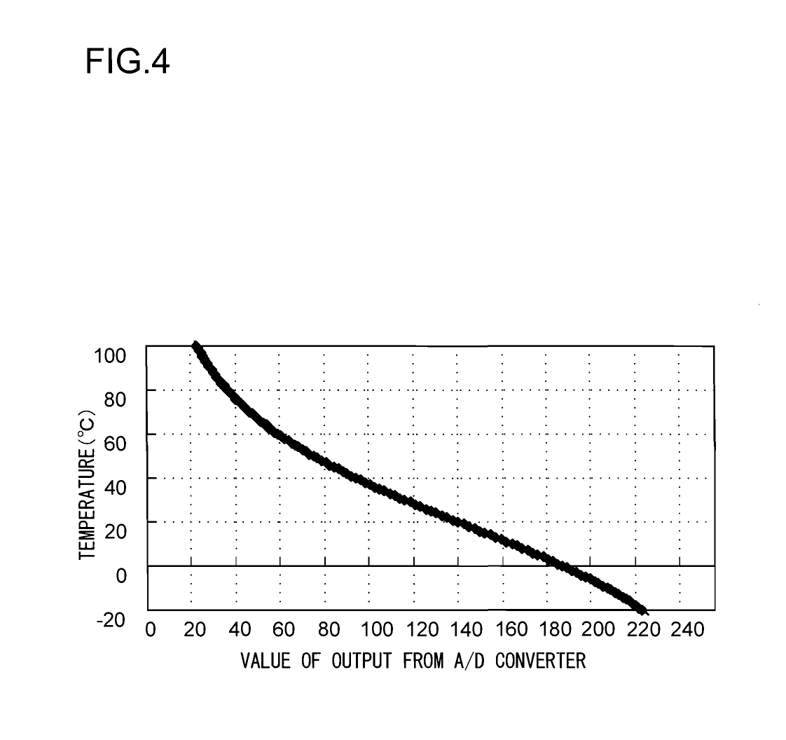

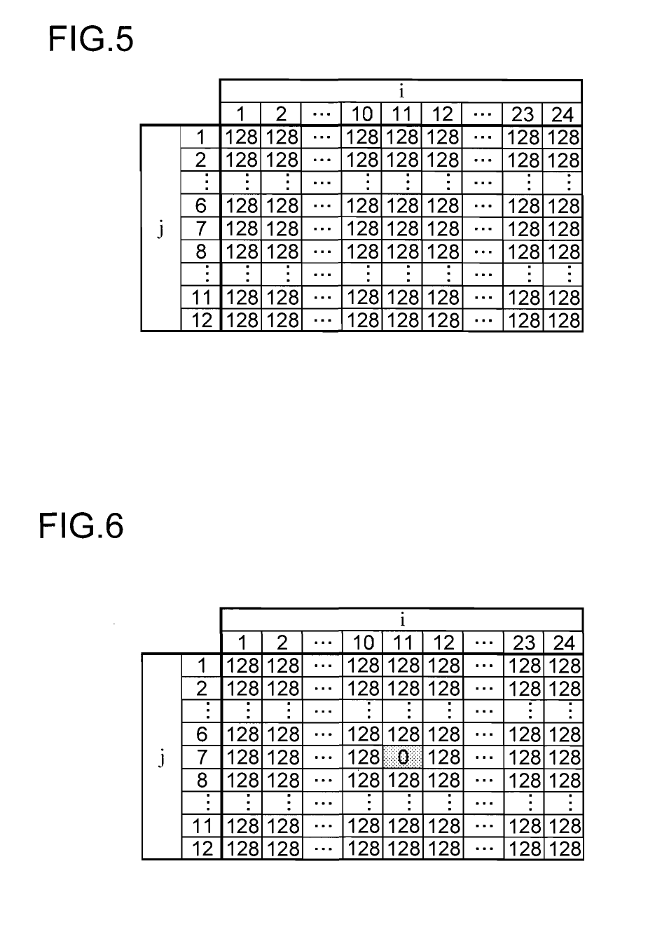

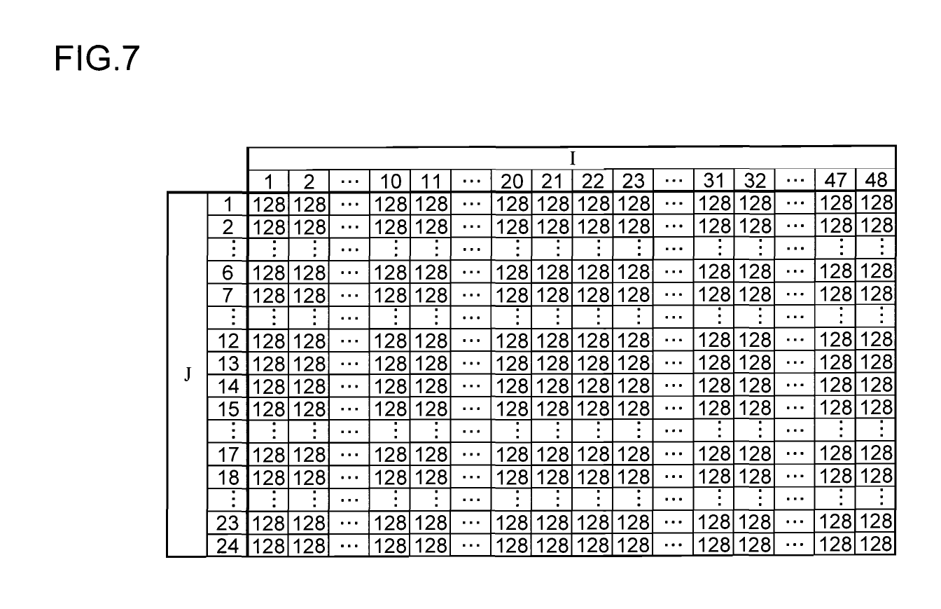

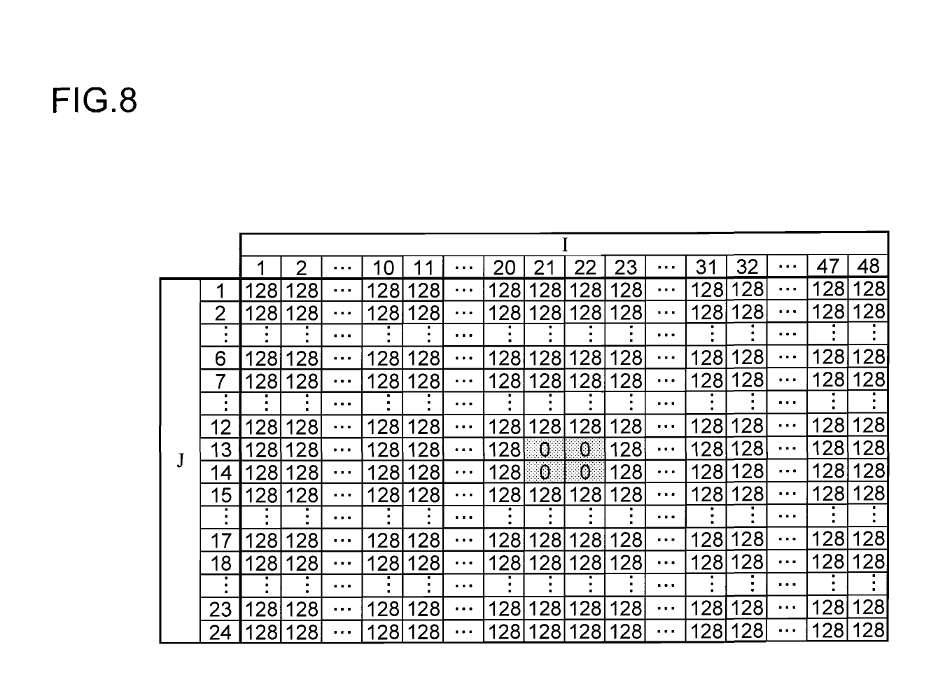

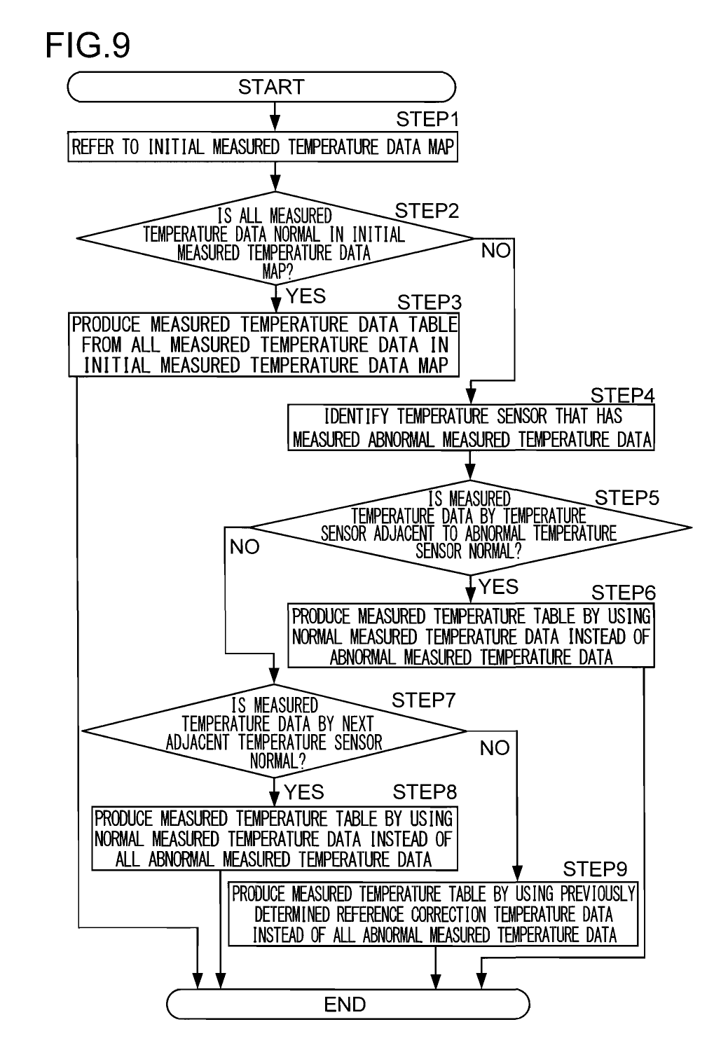

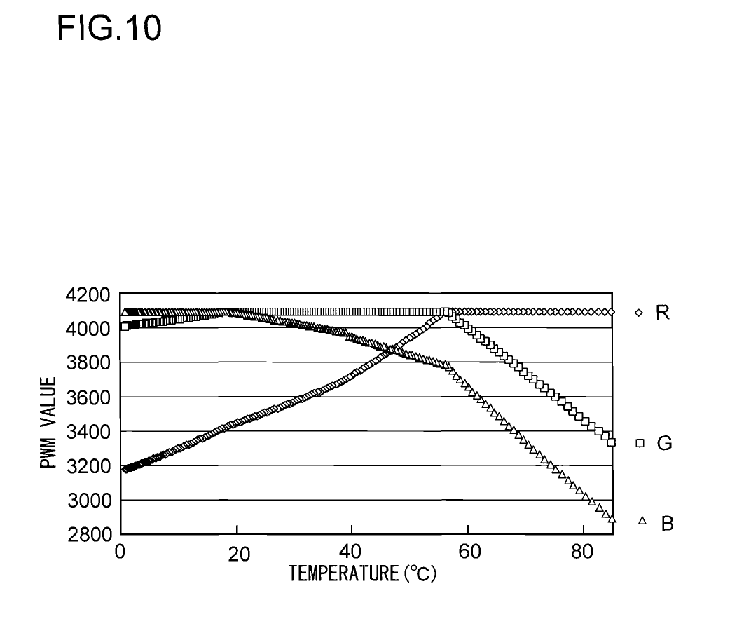

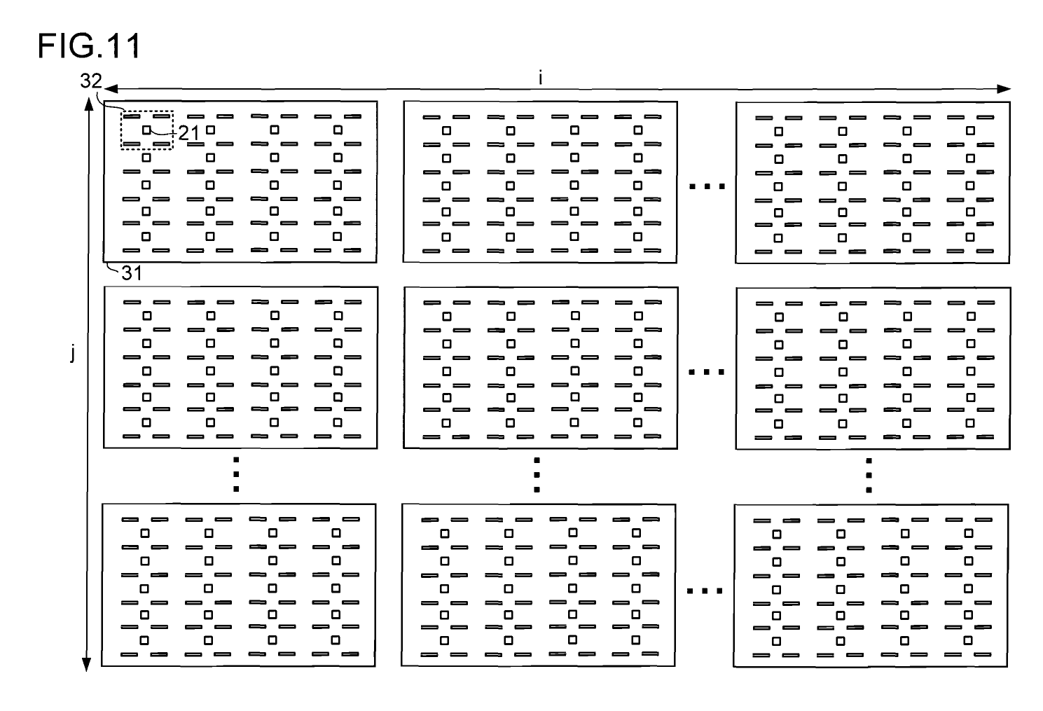

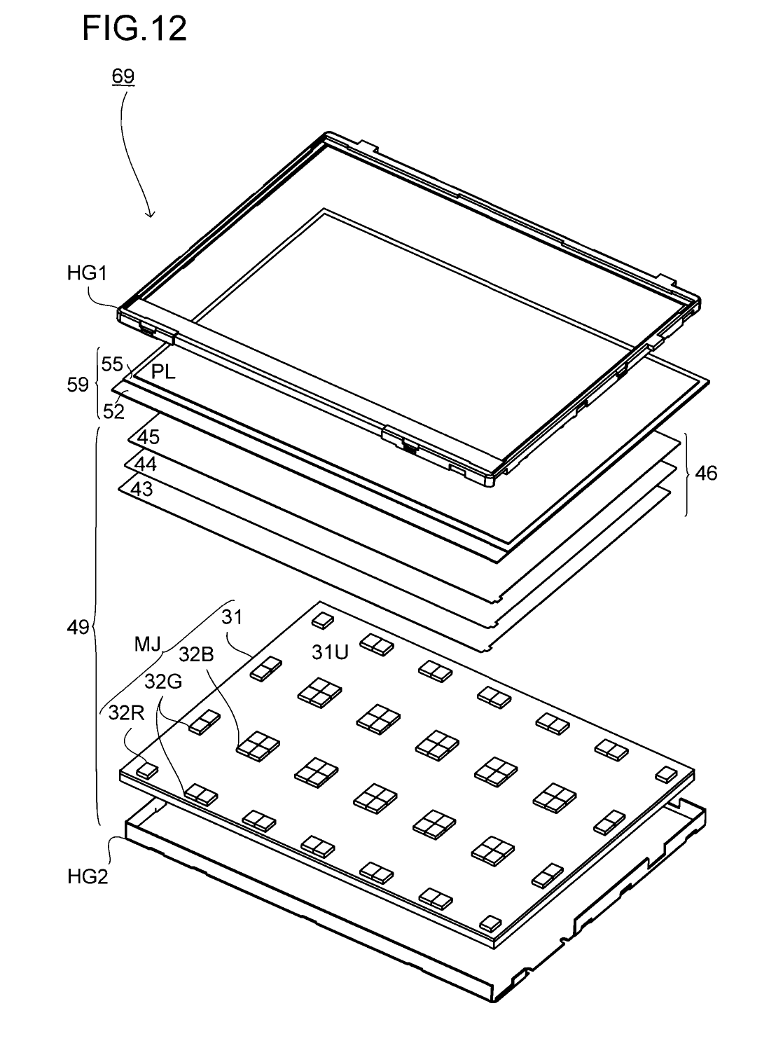

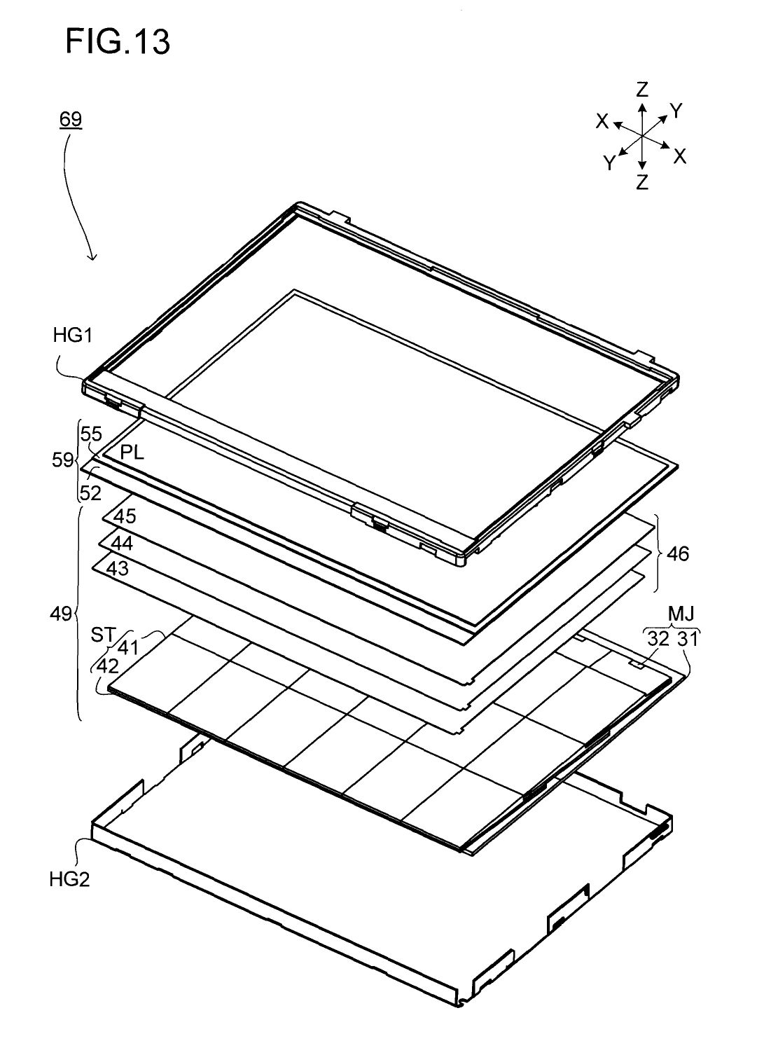

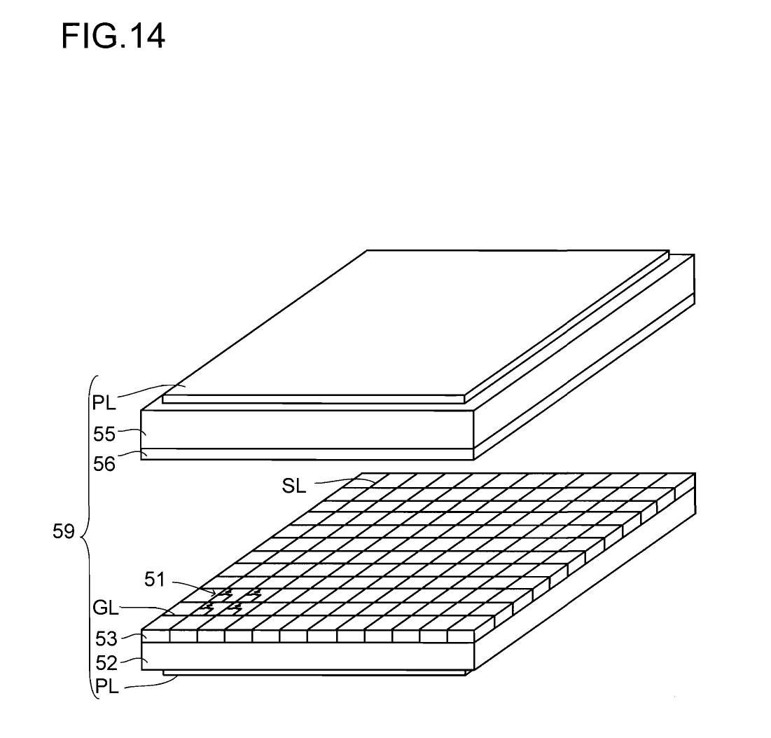

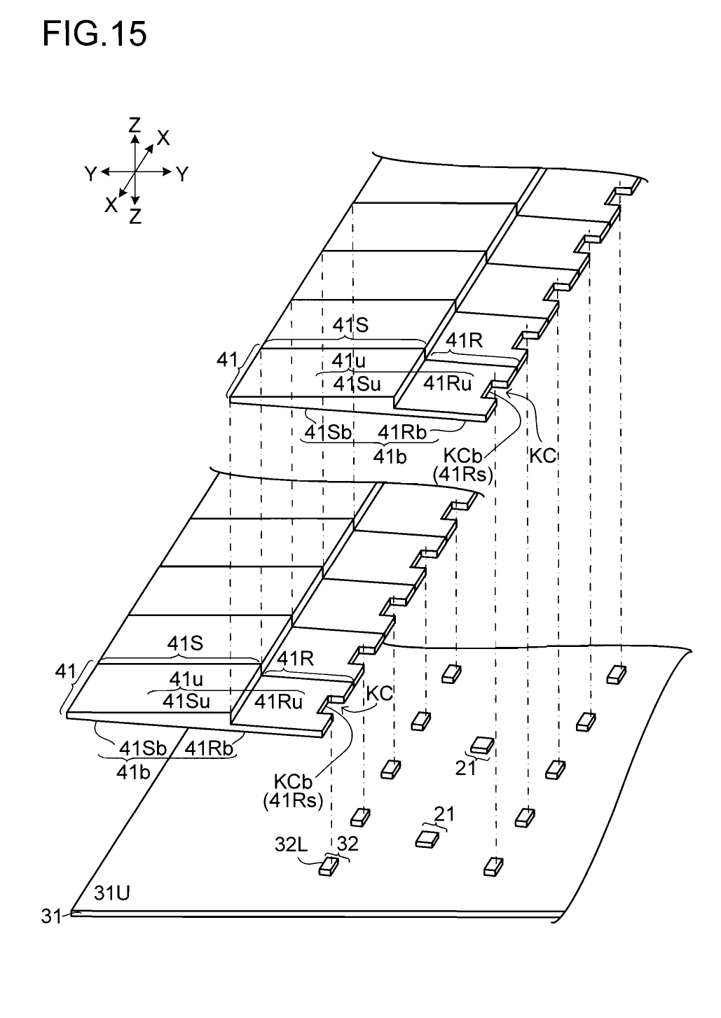

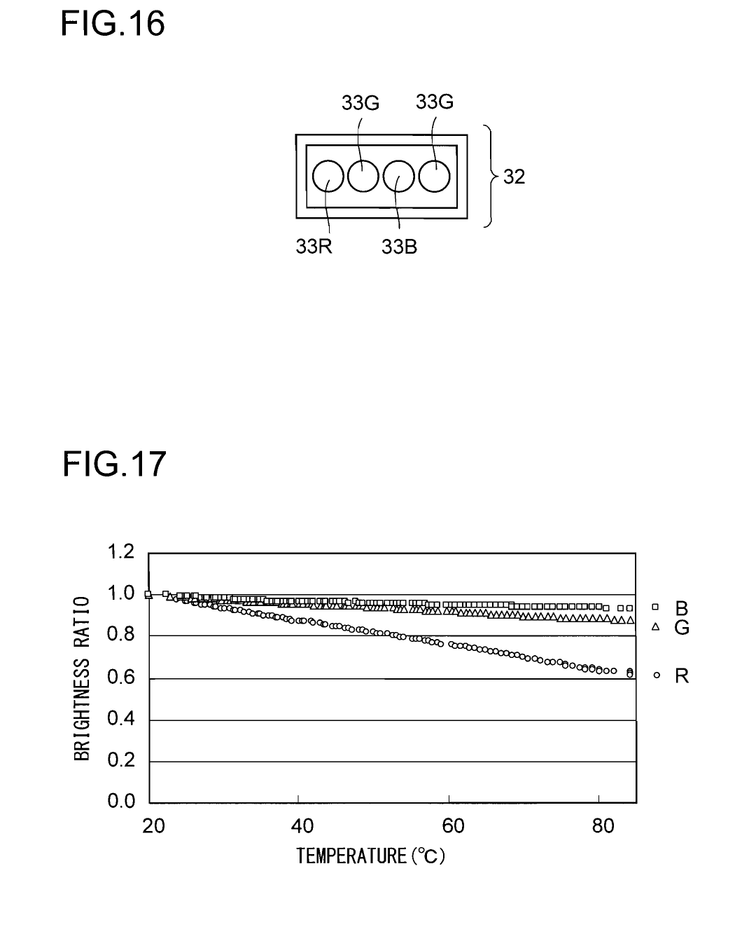

### BRIEF DESCRIPTION OF DRAWINGS

[FIG. 1] A block diagram showing various members included in a liquid crystal display device;

[FIG. 2] A two-side view including a plan view and a side view of a mount board for mounting a temperature sensor necessary for brightness control;

[FIG. 3] A circuit diagram of a temperature sensor and an AD converter;

[FIG. 4] A graph showing the relationship between a temperature measured by a temperature sensor and an output value of an AD converter;

[FIG. 5] An example of an initial measured temperature data map of a case where all temperature sensors are normal;

[FIG. 6] An example of an initial measured temperature data map of a case where part of temperature sensors are abnormal;

[FIG. 7] A measured temperature data table produced based on the initial measured temperature data map shown in FIG. 5;

[FIG. 8] A measured temperature data table produced based on the initial measured temperature data map shown in FIG. 6;

[FIG. 9] A flow chart showing operation steps in brightness control performed by an LED controller;

[FIG. 10] A graph based on a PWM table;

[FIG. 11] A plan view of a mount board for mounting a temperature sensor necessary for brightness control;

[FIG. 12] An exploded perspective view of a liquid crystal display device;

[FIG. 13] An exploded perspective view of a liquid crystal display device;

[FIG. 14] A schematic perspective view of a liquid crystal display panel included in a liquid crystal display device;

[FIG. 15] An exploded perspective view showing part of a backlight unit included in a liquid crystal display device;

[FIG. 16] A front view of an LED; and

[FIG. 17] A graph showing the temperature dependence of brightness of each light emitting chip.

### DESCRIPTION OF EMBODIMENTS

### Embodiment 1

Hereinafter, an embodiment of the present invention will be described based on the drawings. Reference signs for members and the like may sometimes be omitted for ease of description, and in such a case, a different drawing is to be referred to. Numerical examples herein are described as examples, and the present invention is by no means limited thereto.

FIG. 13 is an exploded perspective view showing a liquid crystal display device 69 (as to the number of light guide plates 41 which will be described later, only a comparatively small number of them are illustrated for the sake of convenience). FIG. 14 is a schematic perspective view of a liquid crystal display panel 59 included in the liquid crystal display device 69, and FIG. 15 is an exploded perspective view showing part of a backlight unit 49 included in the liquid crystal display device 69.

As shown in FIG. 13, the liquid crystal display device 69 includes the liquid crystal display panel 59, the backlight unit 49, and housings HG (HG1, HG2) between which the liquid crystal display panel 59 and the backlight unit 49 are sandwiched.

The liquid crystal display panel 59 adopts an active matrix method. Thus, in the liquid crystal display panel 59, liquid crystal (not shown) is sandwiched between an active matrix substrate 52 to which active elements such as TFTs (thin film transistors) 51, etc. are fitted and a counter substrate 55 that faces the active matrix substrate 52. That is, the active matrix substrate 52 and the counter substrate 55 are substrates for sandwiching the liquid crystal therebetween, and they are formed of transparent glass or the like.

Incidentally, an unillustrated seal material is fitted to the periphery of the active matrix substrate 52 and the counter substrate 55, and the seal material seals the liquid crystal. Furthermore, polarization films PL and PL are fitted such that the substrates are placed between the polarization films PL and PL.

As shown in FIG. 14, the active matrix substrate 52 has, formed on a surface thereof facing the counter substrate 55, gate signal lines GL, source signal lines SL, TFTs (switching elements) 51, and pixel electrodes 53.

The gate signal lines GL transmit gate signals (scan signals) that control ON/OFF states of the TFTs 51, while the source signal lines SL transmit source signals (image signals) that are necessary for image display. These two types of lines GL and SL are aligned.

Specifically, on the active matrix substrate 52, the aligned gate signal lines GL cross the aligned source signal lines SL such that a matrix pattern is formed by the two types of lines GL and SL. Regions divided by the gate signal lines GL and the source signal lines SL correspond to pixels of the liquid crystal display panel 59 (if the liquid crystal display panel 59 is a full high vision display panel, 1920×1080 pixels are included).

Incidentally, gate signals that are transmitted through the gate signal lines GL are generated by a gate driver (not shown), and source signals that are transmitted through the source signal lines SL are generated by a source driver (not shown).

The TFTs 51 are located at cross points of the gate signal lines GL and the source signal lines SL, and control the ON/OFF states of the pixels of the liquid crystal display panel 59 (incidentally, only part of the TFTs 51 are illustrated for the sake of convenience). That is, the TFTs 51 control the ON/OFF states of the pixels by using gate signals transmitted through the gate signal lines GL.

The pixel electrodes 53 are electrodes connected to drains of the TFTs 51, and arranged corresponding to the pixels (that is, the pixel electrodes 53 are arranged next to one another with no space among them to form a matrix on the active matrix substrate 52). And the pixel electrodes 53, together with a later-described common electrode 56, hold the liquid crystal such that the liquid crystal is sandwiched between the pixel electrodes 53 and the common electrode 56.

The counter substrate 55 has the common electrode 56 formed on a surface thereof facing the active matrix substrate 52.

The common electrode 56 is, in contrast to the pixel electrodes 53, arranged corresponding to a plurality of pixels (that is, the common electrode 56 occupies an area of the counter substrate 55 wide enough to cover the plurality of pixels). And the liquid crystal is sandwiched between the common electrode 56 and the pixel electrodes 53. With this structure, when a potential difference appears between the common electrode 56 and the pixel electrodes 53 corresponding to the pixels, the liquid crystal changes its own transmittance by using the potential difference (incidentally, the liquid crystal display panel 59 in which the liquid crystal is controlled on a pixel-by-pixel basis is called an active-area-type liquid crystal display panel 59).

In the above-described liquid crystal display panel 59, when a gate signal voltage is fed via a gate signal line GL to a TFT 51 and the TFT 51 is turned ON, a source signal voltage at a source signal line SL is fed via a source and a drain of the TFT 51 to a pixel electrode 53. And, according to the source signal voltage, a voltage of a source signal is written onto a part of the liquid crystal between the pixel electrode 53 and the common electrode 56, that is, a part of the liquid crystal that corresponds to a pixel. On the other hand, when the TFT 51 is in an OFF state, the source signal voltage remains held by the liquid crystal and a capacitor (not shown). That is, by turning ON/OFF the TFT 51 in this way, the liquid crystal partly changes its transmittance, and thereby displays an image.

Next, a description will be given of the backlight unit 49 that supplies light to the liquid crystal display panel 59. The backlight unit 49 irradiates, with light, the liquid crystal display panel 59 which does not emit light by itself That is, the liquid crystal display panel 59 exerts its display function by receiving light (backlight light) from the backlight unit 49. Thus, the display quality of the liquid crystal display panel 59 will be improved by uniform irradiation of the entire surface of the liquid crystal display panel 59 with the light from the backlight unit 49.

The backlight unit 49 includes an LED module (a light-emitting module) MJ, a light guide plate set ST, a diffusion sheet 43, and prism sheets 44 and 45.

The LED module MJ is a module that emits light, and as shown in FIG. 15 which is a partly enlarged exploded perspective view, the LED module MJ includes: a mount board 31; and an LED (a light emitting diode) 32 mounted on an unillustrated electrode formed on a mount board surface 31U of the mount board 31 to thereby receive a supply of current to emit light.

Preferably, the LED module MJ includes, for the purpose of securely obtaining desired amount of light, a plurality of LEDs (light sources) 32 as light emitting devices. Still preferably, the LEDs 32 are arranged in a matrix. In the figure, however, for the sake of convenience, only part of the LEDs 32 are illustrated (incidentally, hereinafter, a direction in which the LEDs 32 are aligned will be referred to as an X direction, and a direction that (for example, perpendicularly) crosses the X direction will be referred to as a Y direction).

Note that there is no particular limitation to the type of the LEDs 32. For example, each of the LEDs 32 may be structured, as shown in the front view of the LED 32 shown in FIG. 16, such that a red-light-emitting (R) light emitting chip 33R, a green-light-emitting (G) light emitting chip 33G, and a blue-light-emitting (B) light emitting chip 33B are aligned to generate white light by color mixing (it is assumed that the LED 32 shown in FIG. 16 is adopted in Embodiment 1).

In such an LED32, as shown in FIG. 17, the light emitting chips 33R, 33G, and 33B show different temperature-dependent brightness deterioration rates (degradation of brightness). Incidentally, the term “brightness ratio” in FIG. 17 means a ratio acquired based on the brightness of the light emitting chips 33R, 33G, and 33B that normally emit light under a given temperature (in the figure, “R” denotes light from the light emitting chip 33R, “G” denotes light from the light emitting chip 33G, and “B” denotes light from the light emitting chip 33B).

Further, temperature sensors 21 that measure temperatures of the LEDs 32 and A/D converters (ADC) 22 that convert analog signals from the temperature sensors 21 to digital signals are also mounted on the mount board 31, but their detailed descriptions will be given later.

Next, a description will be given of the light guide plate set ST. The light guide plate set ST includes a light guide plate 41 and a reflection sheet 42.

The light guide plate 41 performs multiple reflection of light that it receives from an LED 32, and outputs the light to the outside. This light guide plate 41 includes, as shown in FIG. 15, a light receiving portion 41R and a light output portion 41S that is connected to the light receiving portion 41R.

The light receiving portion 41R is a plate-like member, and has a cut KC formed in part of a side wall thereof The cut KC is spacious enough to enclose an LED 32 while having a bottom KCb thereof facing a light emitting surface 32L of the LED 32. Thus, with the LED 32 attached so as to fit in the cut KC, the bottom KCb of the cut KC functions as a light receiving surface 41Rs of the light guide plate 41. Incidentally, of two surfaces of the light receiving portion 41R between which the side wall of the light receiving portion 41R are formed, one that faces the mount board 31 will be referred to as a bottom surface 41Rb, and the other that is opposite from the bottom surface 41Rb will be referred to as a top surface 41Ru.

The light output portion 41S is a plate-like member that is placed side by side with, and connected to, the light receiving portion 41R such that the light output portion 41S is located at a position to which light received through the light receiving surface 41Rs proceeds. The light output portion 41S has a bottom surface 41Sb forming a one same surface (flush) with the bottom surface 41Rb of the light receiving portion 41R, and on the other hand, the light output portion 41S has a top surface 41Su that is higher than the top surface 41Ru of the light receiving portion 41R such that a step is formed.

Furthermore, the top surface 41Su and the bottom surface 41Sb of the light output portion 41S are not parallel to each other, but one is inclined with respect to the other. Specifically, the bottom surface 41Sb is inclined such that the bottom surface 41Sb is progressively closer to the top surface 41Su toward the position to which light from the light receiving surface 41Rs proceeds. That is, the thickness (the distance between the top surface 41Su and the bottom surface 41Sb) of the light output portion 41S is gradually reduced toward the position to which light from the light receiving surface 41Rs proceeds, and thus the light output portion 41S tapers off (incidentally, the light guide plate 41 including the thus tapering-off light output portion 41S is also called a wedge light guide plate 41).

The light guide plate 41 including the above-described light receiving portion 41R and the light output portion 41S receives light through the light receiving surface 41Rs, performs multiple reflection of the light between the bottom surface 41b (41Rb, 41Sb) and the top surface 41u (41Ru, 41Su), and outputs the light to the outside (incidentally, the light outputted from the top surface 41Su is called planar light).

However, there may be a case where the light is outputted through the bottom surface 41b, depending on the incidence angle of the light with respect to the bottom surface 41b. To prevent such a case, the reflection sheet 42 covers the bottom surface 41b of the light guide plate 41, and reflects light leaking from the bottom surface 41b back to the inside of the light guide plate 41 (however, in FIG. 15, for the sake of convenience, the reflection sheet 42 is omitted).

Incidentally, as the light guide plate 41 described above, a plurality of light guide plates 41 are included in the light guide plate set ST to be arranged in a matrix corresponding to the LEDs 32. In particular, in a case where the light guide plate set ST is aligned along the Y direction, the top surfaces 41Ru of the light receiving portions 41R support the bottom surfaces 41Sb of the light output portions 41S, and the top surfaces 41Su are assembled together to form a one same surface (the top surfaces 41Su are assembled together to be flush with each other).

Furthermore, also in a case where the light guide set ST is aligned along the X direction, the top surfaces 41Su are assembled together to form a one same surface. As a result, the top surfaces 41Su of the light guide plates 41, by being arranged in a matrix, forms a comparatively large light emission surface (incidentally, the light guide plates 41 arranged in a matrix will also be referred to as tandem light guide plates 41).

The diffusion sheet 43 is placed so as to cover the top surfaces 41Su of the light guide plates 41 arranged in a matrix, and diffuses planar light coming from the light guide plates 41 to deliver the light to every region of the liquid crystal display panel 59 (incidentally, the diffusion sheet 43 and the prism sheets 44 and 45 together will also be referred to as an optical sheet group 46).

The prism sheets 44 and 45 are optical sheets that each have a prism-like shape in its sheet surface and that deflect the radiation characteristic of light, and they are placed so as to cover the diffusion sheet 43. As a result, the optical sheets 44 and 45 collect light coming from the diffusion sheet 43, and this helps achieve improved brightness. Incidentally, a direction in which light collected by the prism sheet 44 is dispersed and a direction in which light collected by the prism sheet 45 is dispersed cross each other.

Next, the housings HG will be described. The housings HG, which are specifically a front housing HG1 and a rear housing HG2, sandwich and fix therebetween the above-described backlight unit 49 and liquid crystal display panel 59 that covers the backlight unit 49 (incidentally, there is no particular limitation to the fixing method). That is, the front housing HG1 and the rear housing HG2 sandwich the backlight unit 49 and the liquid crystal display panel 59 which are placed between them, and thus the liquid crystal display device 69 is completed.

Incidentally, the rear housing HG2 accommodates therein the light guide plate set ST, the diffusion sheet 43, the prism sheets 44 and 45 stacked in this order, and the stacking direction will be referred to as a Z direction (the X direction, the Y direction, and the Z direction may be perpendicular to one another).

In the backlight unit 49 described above, light from the LEDs 32 is outputted as planar light by passing through the light guide plate set ST, and the planar light passes through the optical sheet group 46 to be outputted as backlight light having enhanced brightness. And, the backlight light reaches the liquid crystal display panel 59, which displays an image by using the backlight light.

The backlight unit (the tandem-type backlight unit) 49 incorporating the tandem light guide plates 41 is capable of controlling output of light from each of the light guide plates 41, and thus is capable of partly illuminating a display region of the liquid crystal display panel 59. Therefore, it can also be said that the backlight unit 49 as described above is an active-area-type backlight unit 49.

Now, with reference to FIGS. 1 to 10, in addition to FIGS. 13 to 17, a description will be given of how brightness is controlled in the active-area-type backlight unit 49 described above. FIG. 1 is a block diagram showing various members necessary in describing the brightness control. FIG. 1 shows an LED 32, a temperature sensor 21, and an A/D converter 22 of the plurality of LEDs 32, temperature sensors 21, and A/D converters 22, respectively, for the sake of convenience.

FIG. 2 is a two-side view including a plan view and a side view of the mount board 31 for mounting the temperature sensors 21 necessary for controlling the brightness. FIG. 3 is a circuit diagram of the temperature sensor 21 and the A/D converter 22, and FIG. 4 is a graph showing the relationship between a temperature measured by the temperature sensor 21 and a value of output from the A/D converter 22.

FIGS. 5 and 6 show later-described initial measured temperature data maps, and FIGS. 7 and 8 show later-described measured temperature data tables. FIG. 9 is a flow chart showing operation steps of brightness control performed by an LED controller 11. FIG. 10 is a graph based on a later-described PWM table.

As shown in FIG. 1, the liquid crystal display device 69 includes: a signal receiving portion 25, a video signal processing portion 26, a liquid crystal display panel controller 27; the LEDs 32, an LED driver 34; the temperature sensors 21, the A/D converters 22; the LED controller 11; and an external memory 28.

The signal receiving portion 25, for example, receives video and audio signals such as television broadcast signals (see an outline arrow) (incidentally, hereinafter, the description will be focused on video signals). The signal receiving portion 25 sends a video signal that it has received to the video signal processing portion 26.

The video signal processing portion 26 produces a video processing signal based on the video signal that it has received. Then, the video signal processing portion 26 sends the video processing signal to the liquid crystal display panel controller 27 and the LED controller 11. Incidentally, the video processing signal, for example, includes color video signals indicating colors (a red video signal RS, a green video signal GS, a blue video signal BS, etc.), and synchronization signals related to the color video signals (a clock signal CLK, a vertical synchronization signal VS, a horizontal synchronization signal HS, etc.).

The liquid crystal display panel controller 27, based on the video processing signal, controls the pixels of the liquid crystal display panel 59.

The LED 32, as described above, includes one light emitting chip 33R, two light emitting chips 33G, and one light emitting chip 33B. These light emitting chips 33 are controlled by a pulse width modulation method (which will be described later in detail).

The LED driver 34, based on a signal from the LED controller 11 which will be described later in detail, turns ON/OFF the LEDs 32.

The temperature sensors 21 measure temperatures of the LEDs 32. Here, the temperature sensors 21 do not correspond to the LEDs 32 on a one-to-one basis, but for example, as shown in FIG. 2, each of the temperature sensors 21 correspond to four LEDs 32 (see a dotted-line box) (however, this correspondence is not meant as limitation).

Thus, for example, in a case where the light guide plates 41 are arranged in 48 lines in the X direction and in 24 lines in the Y direction, the temperature sensors 21 are arranged in 24 lines in the X direction and in 12 lines in the Y direction (for the sake of convenience, among the LEDs 32 that are arranged in a matrix, an LED 32 located in a corner is considered as a reference, and positions of the temperature sensors 21 in the X direction are indicated by “i” (1≦i≦24) and positions of the temperature sensors 21 in the Y direction are indicated by “j” (1≦j≦12)).

There are various types of temperature sensors 21, but in the liquid crystal display device 69 (specifically, the backlight unit 49) of this embodiment, as shown in FIG. 3, a temperature sensor 21 using a thermistor TT is adopted. The temperature sensors 21 are interposed between the wedge-shaped light guide plates 41 and the mount board 31.

The A/D converter 22 converts an analog signal from the temperature sensor 21 to a digital signal, and sends the digital signal to the LED controller 11. Specifically, as shown in FIG. 3, a resistance value of the thermistor TT included in the temperature sensor 21 is fed to the A/D converter 22.

And the A/D converter 22 converts the analog signal, by using a voltage from GND to VDD, for example, to an 8-bit (0 to 255) digital signal, and sends the digital signal to the LED controller 11. That is, the A/D converter 22 converts the resistance value of the thermistor TT, which changes according to change in temperature, to a digital signal of any value of 0 to 255 as shown in FIG. 4, and sends the digital signal to the LED controller 11 (hereinafter, as the case may be, the digital signal will be referred to as measured temperature data).

In view of the durable temperature of the LEDs 32, the temperature sensors 21 do not have to measure an excessively low or high temperature. Accordingly, in a case where a digital signal indicating such an excessively low or high temperature is outputted from the A/D converter 22, it can be judged that the temperature sensor 21 is abnormal (for example, in cases where the measured temperature data is 0 to 10 or 245 to 255, it can be judged that the temperature sensor 21 is abnormal).

The A/D converter 22 sends, in addition to the measured temperature data, data of information of locations (LED location information data) of the LEDs 32 on the mount board 31 to the LED controller 11. It should be noted that the correspondence between the temperature sensors 21 and the A/D converters 22 is not on a one-to-one basis, but, for example, one A/D converter 22 corresponds to eight temperature sensors 21 (however, this correspondence is not meant as a limitation). Hence, the A/D converter 22 also sends location information data (ADC location information data) of the A/D converter 22 itself to the LED controller 11.

The LED controller 11, based on the video processing signal sent from the video signal processing portion 26 and the measured temperature data and the location information data sent from the A/D converter 22, adjusts the brightness of the LEDs 32. There are various methods of brightness adjustment, among which the LED controller 11 adopts a pulse width modulation (PWM) method, and adjusts the brightness of the LEDs 32 by adjusting light emission time of the LEDs 32.

Accordingly, the LED controller 11 includes a pulse width modulation unit 18 that modulates a pulse width, and further includes an LED driver control portion 12 and a temperature management portion 13.

The LED driver control portion 12 sends the color video signals (the red video signal RS, the green video signal GS, the blue video signal BS, etc.) from the video signal processing portion 26 to the pulse width modulation unit 18. The LED driver control portion 12 generates, from the synchronization signals (the clock signal CLK, the vertical synchronization signal VS, the horizontal synchronization signal HS, etc.), a lighting timing signal TS for the LEDs 32 (specifically, the light emitting chips 33), and sends the lighting timing signal TS to the LED driver 34.

The temperature management portion 13 includes a conversion data storing portion 14, a measured temperature data table producing portion 15, and a measured temperature data table storing portion 16.

The conversion data storing portion 14 stores the measured temperature data and the location information data (the LED location information data and the ADC location information data) sent from the A/D converter 22. Specifically, as shown in FIG. 5, the conversion data storing portion 14 associates the measured temperature data of the temperature sensor 21 with their locations (i, j) in storing the measured temperature data.

Incidentally, the map of the measured temperature data as shown in FIG. 5 will be referred to as an initial measured temperature data map. And, the initial measured temperature data map of FIG. 5 is an example showing a case where all the temperature sensors 21 are normal, while the initial measured temperature data map of FIG. 6 is an example showing a case where the temperature sensor 21 located at a position where (i, j)=(11, 7) is abnormal.

The measured temperature data table producing portion 15 produces a measured temperature data table by processing an initial measured temperature data map stored in the conversion data storing portion 14. Specifically, the measured temperature data table producing portion 15 produces a measured temperature data table by processing an initial measured temperature data map according to the number of the light guide plates 41, that is, the number of areas of planar light where brightness can be partly controlled.

Examples of the measured temperature data table are shown in FIGS. 7 and 8. The measured temperature data table of FIG. 7 is produced based on the initial measured temperature data map of FIG. 5, and the measured temperature data table of FIG. 8 is produced based on the initial measured temperature data map of FIG. 6. “I” in FIGS. 7 and 8 indicates locations in the X direction of the light guide plates 41 that are determined according to the locations “i” of the temperature sensors 21, and “J” indicates locations in the Y direction of the light guide plates 41 that are determined according to the locations “j” of the temperature sensors 21.

Specifically, from each “i”, “I” of “i×2−1” and “I” of “i×2” are identified, and from each “j”, “J” of “j×2−1” and “J” of “j×2” are identified. Thus, in FIG. 7, the measured temperature data is “128” for all the locations (I, J). On the other hand, in FIG. 8, the measured temperature data is “0” for the locations where (I, J)=(21, 13), (21, 14), (22, 13), and (22, 14) due to the location where (i, j)=(11, 7), and the measured temperature data is “128” for the other locations (I, J).

However, the measured temperature data table producing portion 15, in the process of producing the measured temperature data table, does not produce a measured temperature table as shown in FIG. 8. That is, the measured temperature data table producing portion 15, in the step of producing the measured temperature data table according to the initial measured temperature data map of FIG. 6, does not adopt the measured temperature data for the location where (i, j)=(11, 7).

Now, with reference to the block diagram of FIG. 1 and the flow chart of FIG. 9, a detailed description will be given of a process in which the measured temperature data table producing portion 15 does not use measured temperature data of an abnormal temperature sensor 21 but uses substitute temperature data.

First, normally, the measured temperature data table producing portion 15 refers to the initial measured temperature data map stored in the conversion data storing portion 14 (STEP 1), and checks whether or not all the measured temperature data in the initial measured temperature data map is normal (STEP 2; STEP 2 is a temperature sensor judgment step). Then, if all the measured temperature data is normal, that is, for example, if the measured temperature data is within the range of 11 to 244, the measured temperature data table producing portion 15 produces a measured temperature data table from all the measured temperature data in the initial measured temperature data map (YES in STEP 2, STEP 3, see FIG. 7).

However, if the measured temperature data table producing portion 15 finds abnormal data among the measured temperature data in the initial measured temperature data map (NO in STEP 2), a temperature sensor 21 that has measured the abnormal measured temperature data is identified (STEP 4). Furthermore, the measured temperature data table producing portion 15 judges whether measured temperature data by a temperature sensor 21 next to the identified abnormal temperature sensor 21 (which will also be referred to as a first abnormal temperature sensor) is normal or abnormal (STEPS; STEPs 2, 4, 5 are temperature sensor judgment steps).

If the measured temperature data of the temperature sensor 21 adjacent to the first abnormal temperature sensor 21 is normal, the measured temperature data table producing portion 15 adopts the normal measured temperature data instead of the abnormal measured temperature data of the first abnormal temperature sensor 21 to produce a measured temperature data table (STEP 6 in response to YES in STEP 5; STEP 6 is a substitute control step).

However, in a case where the measured temperature data of the temperature sensor 21 adjacent to the first abnormal temperature sensor 21 is also abnormal (the adjacent abnormal temperature sensor 21 will also be referred to as a second abnormal temperature sensor) (NO in STEP 5), the measured temperature data table producing portion 15 judges whether measured temperature data by a temperature sensor 21 adjacent to the second abnormal temperature sensor 21 is normal or abnormal (STEP 7; STEP 7 is a temperature sensor judgment step).

If the measured temperature data of the temperature sensor 21 adjacent to the second abnormal temperature sensor 21 is normal, the measured temperature data table producing portion 15 adopts the normal measured temperature data instead of the abnormal measured temperature data of the first and second abnormal temperature sensors 21 and 21 to produce a measured temperature data table (STEP 8 in response to YES in STEP 7; STEP 8 is a substitute control step).

On the other hand, if the measured temperature data of the temperature sensor 21 adjacent to the second abnormal temperature sensor 21 is abnormal, the measured temperature data table producing portion 15, instead of adopting the abnormal measured temperature data of the first and second abnormal temperature sensors 21 and 21, adopts previously determined substitute temperature data (for example, data of an average temperature of the temperature sensors 21; reference correction temperature data) to produce a measured temperature data table (STEP 9 in response to NO in STEP 7; STEP 9 is a substitute control step).

Note that it is assumed that there are a plurality of temperature sensors 21 that are adjacent to an abnormal temperature sensor 21. For example, as shown in FIG. 6, in a case where the temperature sensor 21 located at a position where (i, j)=(11, 7) is abnormal, eight temperature sensors located at positions where (i, j)=(12, 7), (10, 7), (11, 6), (11, 8), (10, 6), (12, 6), (10, 8) and (12, 8) are the adjacent temperature sensors 21. Thus, any one of the eight temperature sensors 21 may be treated as the temperature sensor 21 adjacent to the abnormal temperature sensor 21 located at a position where (i, j)=(11, 7).

In a case where the abnormal temperature sensor 21 is, for example, the temperature sensor 21 located at a location where (i, j)=(1, 1), the adjacent temperature sensors 21 are three temperature sensors 21 that are located at locations where (i, j)=(1, 2), (2, 2) and (2, 2). Thus, any one of the three temperature sensors 21 may be treated as the temperature sensor 21 adjacent to the abnormal temperature sensor 21.

In short, measured data of any temperature sensor 21 may be adopted as a substitute for the measured temperature data of the abnormal temperature sensor 21 as long as the temperature sensor 21 is normal and adjacent to the abnormal temperature sensor 21. Note that, in the case where a normal temperature sensor 21 adjacent to the second abnormal temperature sensor 21 is selected, the first abnormal temperature sensor 21 is not selected for its abnormality, although it is adjacent to the second abnormal temperature sensor 21.

A measured temperature table produced by the measured temperature data table producing portion 15 in the above-described manner is stored in the measured temperature data table storing portion 16. And the temperature management portion 13 sends the measured temperature table stored in the measured temperature data table storing portion 16 to the pulse width modulation unit 18.

The pulse width modulation unit 18 divides one second into, for example, 128 sections, and changes the time width of lighting on a section-by-section basis (for example, changes lighting time based on 12-bit (0 to 4095) values (PWM values)). Specifically, the pulse width modulation unit 18 includes a pulse width modulation portions 19R, 19G, and 19B that correspond to the light emitting chips 33R, 33G, and 33B, respectively, and the pulse width modulation portions 19R, 19G, and 19B control the light emitting chips 33R, 33G, and 33B, respectively, by PWM. Incidentally, the PWM values are previously determined corresponding to temperatures in a form of table (incidentally, this table will be referred to as a PWM table).

The external memory 28 stores the PWM table in which temperatures and the PWM values that are necessary for the PWM control are associated with each other. Specifically, the PWM table is divided for each color (red R, green G, and blue B), and stored in the external memory 28. Incidentally, FIG. 10 is a graph based on an example of the PWM table.

The PWM table corresponds to change in brightness ratio shown in FIG. 17. That is, as shown in FIG. 17, in the light emitting chips 33R, 33G, and 33B, as the temperature rises, the brightness of the light emitting chips 33R and 33G is degraded more than the brightness of the light emitting chip 33B. As a result, if the light emitting chips 33R, 33G, and 33B are supplied with the same value of current to be ON, the brightness of the red light and the green light is degraded as the temperature rises, and this changes the chromaticity, the brightness, and the like of the white light. To prevent this, the PWM table is set such that the brightness ratio of the red light, the brightness ratio of the green light, and the brightness ratio of the blue light are all approximately equal.

And, the pulse width modulation unit 18 (specifically, the pulse width modulation portions 19R, 19G, and 19B) refers to the measured temperature data table and the PWM table, processes the color video signals (the red video signal RS, the green video signal GS, and the blue video signal BS) sent from the LED driver control portion 12 by using the PWM values corresponding to the measured temperature data, and sends the processed signals to the LED driver 34.

And, the LED driver 34, based on the timing signal TS and the processed color video signals received from the LED driver control portion 12, makes the light emitting chips 33R, 33G, and 33B emit light. As a result, light from the light emitting chips 33R, 33G, and 33B has desired brightness without being negatively affected by the measured temperature data of an abnormal temperature sensor 21, and the white light produced by mixing the light form the light emitting chips 33R, 33G, and 33B has high-quality chromaticity.

In light of the foregoing, the backlight unit 49 includes: a plurality of LEDs 32, which are divided into groups of four; and temperature sensors 21 corresponding to the groups of the LEDs 32 on a one-to-one basis. The backlight unit 49 further includes the LED controller 11 that controls the brightness of the LEDs 32 corresponding to the measured temperature data based on the temperatures of the LEDs 32 in the groups measured by the temperature sensors 21.

The LED controller 11 judges from the measured temperature data whether the temperature sensors 21 are normal or abnormal, and controls the brightness of an LED 32 whose temperature is measured by an abnormal temperature sensor 21 based not on the measured temperature data of the abnormal temperature sensor 21 but on substitute temperature data.

That is, the LED controller 11 performs two steps, namely, a temperature sensor judgment step of judging, from the measured temperature data, whether the temperature sensors 21 are normal or abnormal, and a substitute control step of controlling the brightness of an LED 32 whose temperature is measured by an abnormal temperature sensor 21, based not on the measured temperature data of the abnormal temperature sensor 21 but on substitute temperature data.

With this feature, the brightness of the LEDs 32 is controlled without being based on the data of the temperature measured by the abnormal temperature sensor 21. As a result, the white light outputted from the LEDs 32 have desired chromaticity, brightness, etc., and this contributes to improvement of the quality of light from the backlight unit 49.

Incidentally, as an example of the substitute temperature data can be considered measured temperature data based on a temperature measured by a normal temperature sensor 21 that is located closest to the abnormal temperature sensor 21.

Such measured temperature data, which is based on the normal temperature sensor 21 that is located closest to the abnormal temperature sensor 21, is similar to measured temperature data that would be acquired if the abnormal temperature sensor 21 were normal. (That is, a difference between the two measured temperature data is a temperature difference of several degrees Celsius.) Thus, if such measured temperature data is used as the substitute temperature data, the white light outputted from the LEDs 32 securely has desired chromaticity, brightness, etc., and this contributes to improvement of the quality of light from the backlight unit 49.

Incidentally, as described above, if the temperature sensor 21 that is located the closest to the first abnormal temperature sensor 21 is also abnormal, measured temperature data based on a temperature measured by a normal temperature sensor that is located closest to the abnormal temperature sensor (that is, the second abnormal temperature sensor) is used as the substitute temperature data. With this feature, the brightness of the LEDs 32 is securely controlled without being based on the measured temperature data measured by the abnormal temperature sensor 21.

What can also be considered as an example of the substitute temperature data is previously determined substitute temperature data (reference correction temperature data). For example, average temperature data of the temperature sensors 21 may be the substitute temperature data.

With this feature, in a case where three or more adjacent temperature sensors 21 are abnormal, that is, in a case where the first abnormal temperature sensor 21, the second abnormal temperature sensor 21 adjacent to the first abnormal temperature sensor 21, and further, a third abnormal temperature sensor 21 that is adjacent to the second abnormal temperature sensor 21 have been detected, the temperature management portion 13 of the LED controller 11 does not need to judge whether a temperature sensor 21 that is adjacent to the third abnormal temperature sensor 21 is normal or abnormal. That is, the LED controller 11 is relieved of a burden of continuously searching for a normal temperature sensor 21.

In the above descriptions, as shown in the flow chart of FIG. 9, the LED controller 11 searches for a normal temperature sensor 21 in the steps of STEP 2→STEP 4→STEP 5→STEP 7 twice, but the number of times is not limited to twice. That is, the LED controller 11 may search for a normal temperature sensor 21 once or three times or more. However, increase of the number of the times will result in a larger control burden placed on the LED controller 11, and thus it is preferable that the number of the times be set according to the control performance of the LED controller 11.

### Other Embodiments

It should be understood that the embodiments specifically described above are not meant to limit the present invention and that many variations and modifications can be made within the spirit of the present invention.

For example, the mount board 31 is formed as a piece of board, but, as shown in FIG. 11, the mount board 31 may be divided. In a case where the mount board 31 is divided, an abnormal temperature sensor 21 and a normal temperature sensor 21 adjacent to the abnormal temperature sensor 21 may be mounted on a same mount board 31, or may be mounted on different mount boards 31.

Further, in FIGS. 2 and 11, the temperature sensors 21 are provided such that each temperature sensor 21 corresponds to a group of four LEDs 32. This, however, is not meant as a limitation. Specifically, the LEDs 32 may be divided into groups of one, two, or three LEDs 32, or may be divided into groups of five or more LEDs 32. Further, it is not necessary that all the groups include the same number of LEDs 32.

Among the plurality of LEDs 32, there exists a difference in performance (for example, brightness). In short, individual variation exists among the plurality of LEDs 32. To cope with this, the LED driver control portion 12 in the LED controller 11 further includes a PWM table for adjustment of reducing unevenness in chromaticity and brightness, etc. resulting from the individual variation, and correction may be performed by using it.

The descriptions hereinabove have dealt with, as an example, the tandem-type backlight unit 49 in which wedge-shaped light guide plates 41 are arranged next to one another with no space among them. This, however, is not meant as a limitation. For example, as shown in FIG. 12, the backlight unit 49 may be such that the LED 32R, the LED 32G, the LED 32G, and the LED 32B together produce white light by mixing color, and that the light is outputted directly toward the optical sheet group 46. In other words, the backlight unit 49 may be a direct backlight unit 49.

Further, the descriptions hereinabove have dealt with cases where the signal receiving portion 25 receives video and audio signals such as a television broadcasting signals and the video signal processing portion 26 processes the video signals included in the signals. Thus, it can be said that the liquid crystal display device 69 is a television broadcast receiving device. However, the video signals that the liquid crystal display device 69 processes are not limited to those for television broadcasting. For example, they may be video signals included in a recording medium on which content such as a movie is recorded, or video signals sent via the Internet.

The LED controller 11 achieves light emission of the LEDs 15 based on a brightness control program. And the brightness control program is executable on a computer, and may be recorded on a recording medium readable by a computer. That is because the program recorded on the recording medium is portable.

Incidentally, examples of the recording medium include a separable tape-type medium such as a magnetic tape or a cassette tape, a disc-type medium such as a magnetic disc or an optical disc such as a CD-ROM, a card-type medium such as an IC card (including a memory card) or an optical card, and a semiconductor memory-type medium such as a flash memory.

Further, the LED controller 11 may acquire the brightness control program by communicating with a communication network. Examples of the communication network include, whether wired or not, the Internet, infrared communication, etc.

### REFERENCE SIGNS LIST

11 LED controller (control portion)

12 LED driver control portion (control portion)

13 temperature management portion (control portion)

14 conversion data storing portion (control portion)

15 measured temperature data table producing portion (control portion)

16 measured temperature data table storing portion (control portion)

18 pulse width modulation unit (control portion)

19 pulse width modulation portion

21 temperature sensor

TT thermistor

22 A/D converter

25 signal receiving portion

26 video signal processing portion

27 liquid crystal display panel controller

28 external memory

MJ LED module

31 mount board

32 LED (light source)

33 light emitting chip (light source)

34 LED driver

ST light guide plate set

41 light guide plate

42 reflection sheet

43 diffusion sheet

44 prism sheet

45 prism sheet

49 backlight unit

59 liquid crystal display panel

69 liquid crystal display device

1. A backlight unit, comprising:
a plurality of light sources;
temperature sensors that are provided corresponding to light source groups into which the plurality of light sources are divided; and
a control portion that controls brightness of the light sources according to measured temperature data that is based on temperatures of the light sources included in the light source groups measured by the temperature sensors,
wherein
the control portion judges whether the temperature sensors are normal or abnormal from the measured temperature data, and the control portion controls brightness of any of the light sources a temperature of which is measured by an abnormal temperature sensor of the temperature sensors, based not on measured temperature data of said abnormal temperature sensor but on substitute temperature data.

2. The backlight unit of claim 1, wherein the substitute temperature data is measured temperature data that is based on a temperature measured by a normal temperature sensor of the temperature sensors that is located closest to said abnormal temperature sensor.

3. The backlight unit of claim 2, wherein, if a temperature sensor of the temperature sensors that is located closest to said abnormal temperature sensor, which is referred to as a first abnormal temperature sensor, is abnormal, the temperature sensor being referred to as a second abnormal temperature sensor, measured temperature data that is based on a temperature measured by a normal temperature sensor of the temperature sensors that is located closest to the second abnormal temperature sensor is used as the substitute temperature data.

4. The backlight unit of claim 1, wherein the substitute temperature data is previously determined temperature data.

5. A liquid crystal display device, comprising:
the backlight unit of claim 1; and
a liquid crystal display panel that receives light from the backlight unit.

6. A brightness control method for a backlight unit that includes:
a plurality of light sources;
temperature sensors that are provided corresponding to light source groups into which the plurality of light sources are divided; and
a control portion that controls brightness of the light sources according to measured temperature data that is based on temperatures of the light sources included in the light source groups measured by the temperature sensors,
the brightness control method comprising:
a temperature sensor judgment step of judging whether the temperature sensors are normal or abnormal from the measured temperature data; and
a substitute control step of controlling brightness of any of the light sources a temperature of which is measured by an abnormal temperature sensor of the temperature sensors, based not on measured temperature data of the abnormal temperature sensor but on substitute temperature data.

7. A tangible computer-readable medium having a brightness control program for a backlight unit that includes:
a plurality of light sources;
temperature sensors that are provided corresponding to light source groups into which the plurality of light sources are divided; and
a control portion that controls brightness of the light sources according to measured temperature data that is based on temperatures of the light sources included in the light source groups measured by the temperature sensors,
wherein
the brightness control program makes the control portion perform brightness control such that judgment of whether the temperature sensors are normal or abnormal is made from the measured temperature data, and that brightness of any of the light sources a temperature of which is measured by an abnormal temperature sensor of the temperature sensors is controlled based not on measured temperature data of the abnormal temperature sensor but on substitute temperature data.

8. (canceled)

9. A liquid crystal display device, comprising:
the backlight unit of claim 2; and
a liquid crystal display panel that receives light from the backlight unit.

10. A liquid crystal display device, comprising:
the backlight unit of claim 3; and
a liquid crystal display panel that receives light from the backlight unit.

11. A liquid crystal display device, comprising:
the backlight unit of claim 4; and
a liquid crystal display panel that receives light from the backlight unit.
